(19) United States
(12) Patent Application Publication
(10) Pub. No.: US 2021/0372148 A1
(43) Pub. Date: Dec. 2, 2021

(54) Handheld Concrete Tie Disjunction Implement

(71) Applicant: Abraham Monarrez, Ogden, UT (US)

(72) Inventor: Abraham Monarrez, Ogden, UT (US)

(21) Appl. No.: 16/890,712

(22) Filed: Jun. 2, 2020

(51) Int. Cl. E04G 17/06

(52) U.S. Cl. CPC E04G 17/0642; B25G 3/36

(57) ABSTRACT

A portable, handheld implement for disjoining protruding concrete ties from reinforced concrete, the handheld implement adapted to apply successive bending and breaking forces to concrete ties, rebar, and the like. An L-shaped head, or chevron-shaped head, in some embodiments, receives the protruding concrete tie and coacts therewith to shear a concrete tie or rebar from a typically planar concrete surface using successive, longitudinally-applied handheld force. A concrete tie is inserted into a recess in the head of the implement designed to securely receive it. Some embodiments of the present invention comprise two L-shaped heads, on at either end of the handle.

### FIELD OF THE INVENTION

This invention relates to devices for breaking and bending rebar and concrete ties, reinforcing rod, and the like, and more particularly relates to a handheld implement for shearing off concrete ties protruding from reinforced concrete.

### BACKGROUND

### Description of the Related Art

Typically, during concrete construction, arrays of reinforcement rods and/or concrete ties are erected within the forms so that when the concrete is poured, the resultant structure is strengthened by the rebar and/or ties. Typically, concrete ties used in the pouring and fabrication of concrete walls and structures protrude, or cantilever, from concrete walls after fabrication. These protruding concrete ties are typically left in place to rust and become at best annoyances; and at worst, safety hazards for children and others who may fall against them, cut themselves, or even become partially impaled.

Although it has been known in the art to attempt to grind, or break, these protruding concrete ties from the concrete walls, breaking the concrete ties in this fashion typically does not shear the ties cleanly from the concrete surface, leaving sharp iron protrusions which can cut those touching them and which prevent use of concrete surfaces for other means.

To be effective, an implement for removing cantilevering concrete ties would need to be simple, portable, relatively powerful, cleanly shear the ties from concrete surfaces, and easily disjoin the ties from the concrete with damaging the adjacent concrete. Devices which serve these functions are unknown in the art, but it is an object of the present invention to now provide one.

### SUMMARY

From the foregoing discussion, it should be apparent that a need exists for a handheld concrete tie disjunction implement. Beneficially, such a pocket assembly would provide a portable, simply, handheld implement for shearing concrete ties from reinforced concrete.

The present invention has been developed in response to the present state of the art, and in particular, in response to the problems and needs in the art that have not yet been fully solved by currently available implement and devices. Accordingly, the present invention has been developed to provide a handheld concrete tie disjunction implement comprising: a chevron-shaped head defining a first hollow interior channel adapted to receive a concrete tie, the hollow interior channel traversing the head from an open front end to an open rearward end; and a second hollow interior recess adapted to receive a handle.

The first hollow interior channel through a cross-section may be one of ovoid and rectangular. The handle may be adapted to be moved to and fro to shear a concrete tie from a cement wall.

The handheld concrete tie disjunction implement may further comprise a plurality of bores for receiving bolts affixing the head to a handle.

The handheld concrete tie disjunction implement may further comprise a second chevron head defining a second hollow interior channel adapted to receive a concrete tie, the second hollow interior channel traversing the head from an open front end to an open rearward end.

A second handheld concrete tie disjunction implement is provided comprising: a first L-shaped head defining a first hollow interior channel adapted to receive a concrete tie, the hollow interior channel traversing the head from an open front end to an open rearward end, the first L-shaped head defining a second hollow interior recess adapted to receive a handle; a second L-shaped head defining a first hollow interior channel adapted to receive a concrete tie, the hollow interior channel traversing the head from an open front end to an open rearward end, the second L-shaped head defining a second hollow interior recess adapted to receive the handle; the handle inserted into the first L-shaped head at a proximal end of the handle and the handle inserted into the second L-shaped head at a distal end of the handle.

The handheld concrete tie disjunction implement, in some embodiments, may further comprise an elongate handle more than two feet in length.

The handle may comprise two prongs adapted to straddle and affix to the head.

In various embodiments, another handheld rebar disjunction implement is provided comprising: a first head defining a first hollow interior channel adapted to receive a concrete tie, the hollow interior channel traversing the head from an open front end to an open rearward end; a second hollow interior recess adapted to receive a handle; and an elongate handle more than two feet in length detachably affixable to the head.

The handheld concrete tie disjunction implement may further comprise a second head defining a second hollow interior channel adapted to receive a concrete tie, the second hollow interior channel traversing the head from an open front end to an open rearward end.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a lower, forward side perspective view illustrating one embodiment of a handheld concrete tie disjunction implement in accordance with the present invention;

FIG. 2 is an isometric perspective view illustrating one embodiment of a handheld concrete tie disjunction implement in accordance with the present invention;

FIG. 3 is an isometric perspective view illustrating one embodiment of a disassembled handheld concrete tie disjunction implement in accordance with the present invention;

FIG. 4 is an isometric perspective view illustrating one embodiment of a handheld concrete tie disjunction implement in accordance with the present invention;

FIG. 5 is an isometric perspective view illustrating one embodiment of a handheld concrete tie disjunction implement in accordance with the present invention;

FIG. 6 is an environmental perspective view illustrating one embodiment of a handheld concrete tie disjunction implement in accordance with the present invention;

FIG. 7 is forward perspective view illustrating one embodiment of a handheld concrete tie disjunction implement in accordance with the present invention;

FIG. 8 is forward perspective view illustrating one embodiment of a handheld concrete tie disjunction implement in accordance with the present invention; and

FIG. 9 is forward perspective view illustrating one embodiment of a handheld concrete tie disjunction implement in accordance with the present invention; and

FIG. 10 is forward perspective view illustrating one embodiment of a handheld concrete tie disjunction implement in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

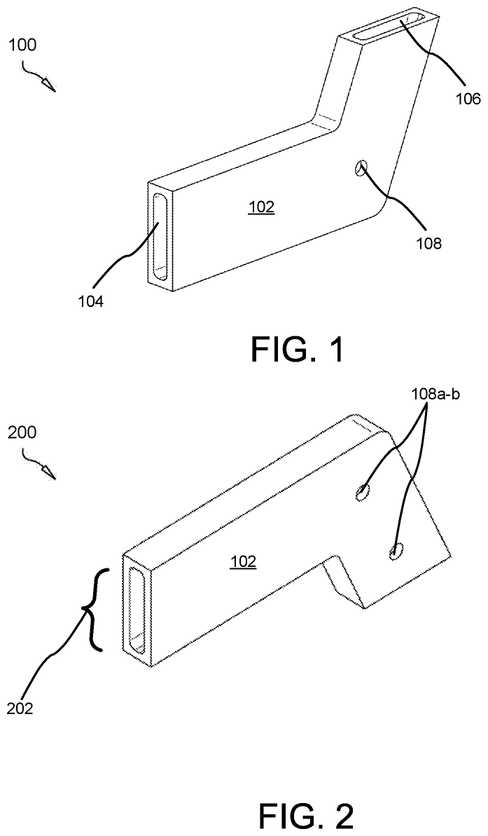

FIG. 1 is a lower, forward side perspective view illustrating one embodiment of the head 100 of a handheld concrete tie disjunction implement in accordance with the present invention.

The head 100 of tie disjunction implement 100 is overall L-shaped or chevron-shaped. As shown, the head 100 of the tie disjunction implement is detachably affixable at a recess 106 to a handle 1006 (further described below) which may comprise a shaft, rod, stick, or other handle 1006 which is insertably received by the head 100 and/or affixed therewith using means known to those of skill in the art, such as bolts inserted into threaded or non-threaded holes 108a-b in the head 100. Alternatively, the handle 1006 may be welded to the head.

The head 300 defines a holler interior recess, or channel 104, which traverses the head front to back between the open front end 202 and the open rear end 309 of the head 100. The head 300 also may comprise a second open bottom end 106 for receiving a handle 304.

When the concrete tie is disjoined from the concrete wall, the broken tie falls out of the open rear end 309. The disjoined tie may slide from the open rear end 309 after being disjoined, or may be pushed out of the open rear end 309 by another concrete tie inserted into the head 300.

In various embodiments, the channel 104 is rectangular or ovoid through a cross-section, or from a forward perspective, such that it closely contours a cement tie of standard size inserts therewith. The implement 100 is used by inserting the head 100 over a cement tie protruding from a dried cement surface and sequentially moving the implement 100 up and down until the cement tie is disjointed from the cement surface. For the reason, the dimensions of the channel 104 must closely match the dimensions of the tie.

In various embodiments, a plurality of heads 100 of different sizes may be interchangeably affixed to a handle or plurality of handles. The handle 1006 may depend from the head at a 90 degree angle from channel 104, or may depend inferiorly at a less than 90 degree angle as shown, between 45 degrees and 90 degrees.

FIG. 2 is an isometric perspective view illustrating one embodiment of a head 200 of handheld concrete tie disjunction implement in accordance with the present invention.

In the shown embodiments, the bores 108 or bolt holes 108 do not completely traverse the head 200 otherwise the superior hole 108 would obstruct the channel 104. Rather, the bores 108 are threaded in the shown embodiment to mate with separate screws on either side of the head 100.

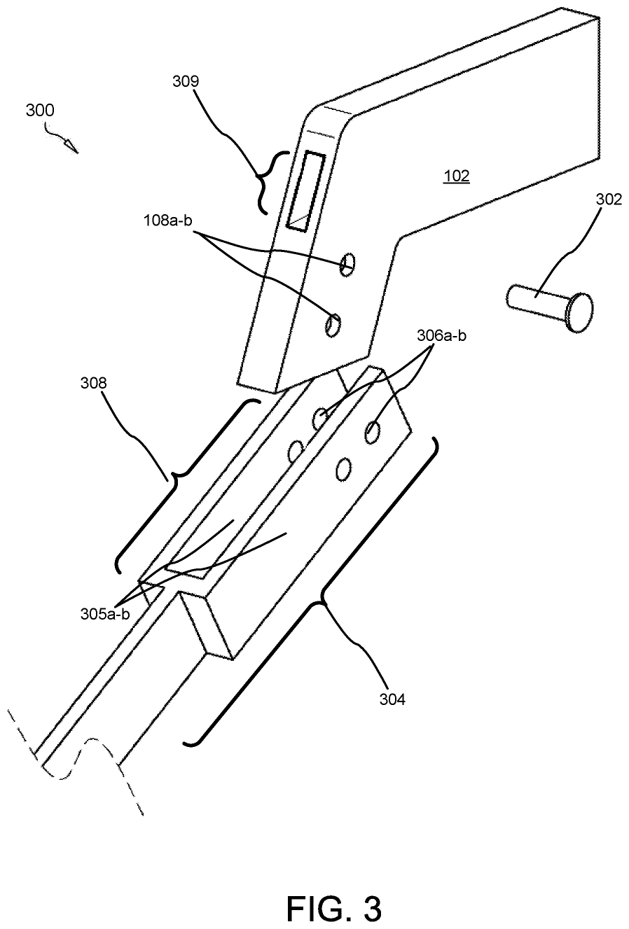

FIG. 3 is an isometric perspective view illustrating one embodiment of a disassembled handheld concrete tie disjunction implement 300 in accordance with the present invention.

The bolts inserted into bores 108 in the shown embodiment traverse the head 100 entirely as the corresponding bolt hole 108 is inferiorly-disposed to the channel 104.

In the shown the embodiment, the handle 304 comprises a pair of prongs 305a-b which straddle the head 100 and affix therewith. The prongs 305a-b together comprise affixment means 308. The handle 304 may be welded to the head 100.

The handle 304 is adapted to be moved forward and backward (i.e., to and fro) to shear a concrete tie from a cement wall. Alternatively, the handle 304 may be moved upward and downward in sequential alternate fashion.

The handle 304 may comprise an elongate tube, pipe, shaft, rod or the like, and may be more than two feet in length.

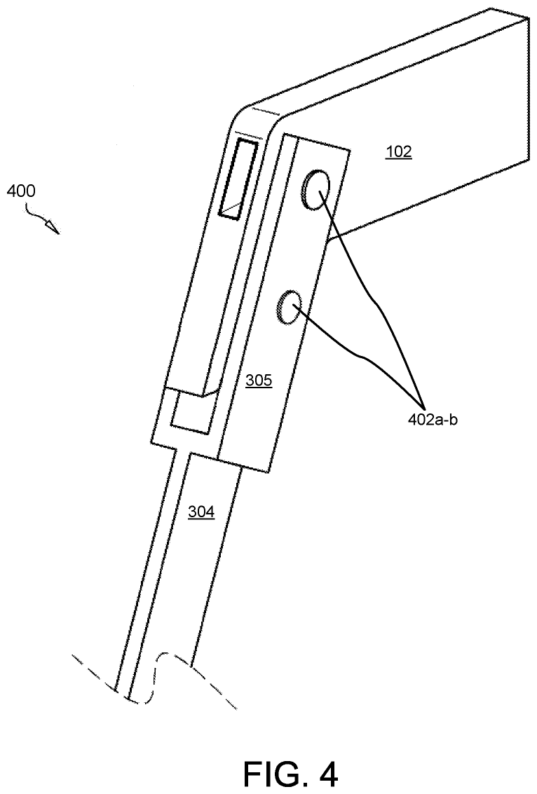

FIG. 4 is an isometric perspective view illustrating one embodiment of a handheld concrete tie disjunction implement 400 in accordance with the present invention.

The bolts 402 in the shown embodiment do not completely traverse the head 100.

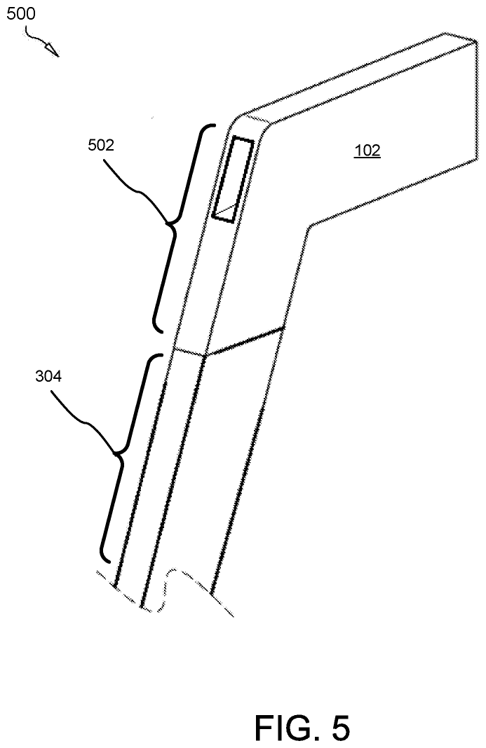

FIG. 5 is an isometric perspective view illustrating one embodiment of a handheld concrete tie disjunction implement 500 in accordance with the present invention.

In the shown embodiment, the handle 304 inserts into the lower leg 502 of the head 100. The lower leg 502 defines a hollow interior recess with an open bottom end for receiving the handle 304.

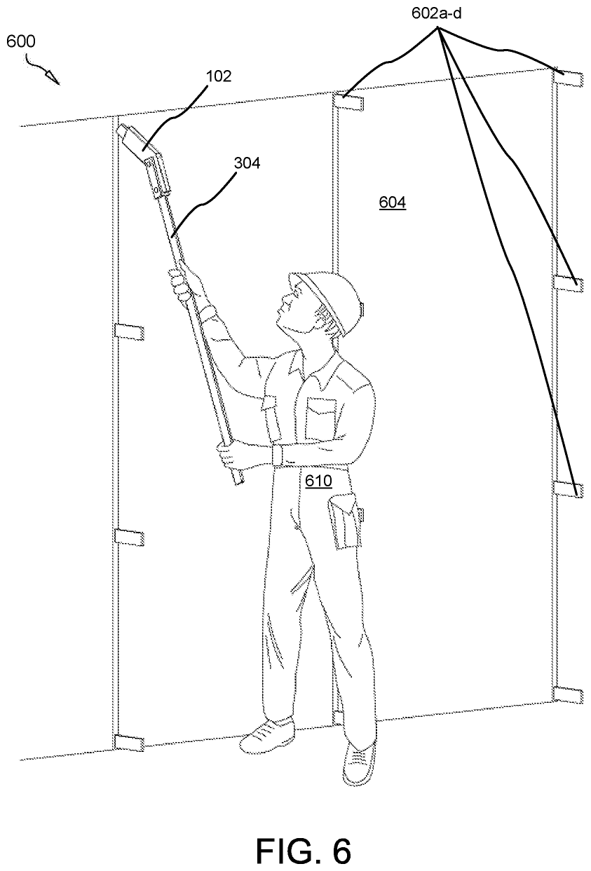

FIG. 6 is an environmental perspective view illustrating one embodiment of a handheld concrete tie disjunction implement 600 in accordance with the present invention.

The worker 610 manipulates the implement 600 using upward and downward movement to shear the concrete ties 602 from the concrete surface 604.

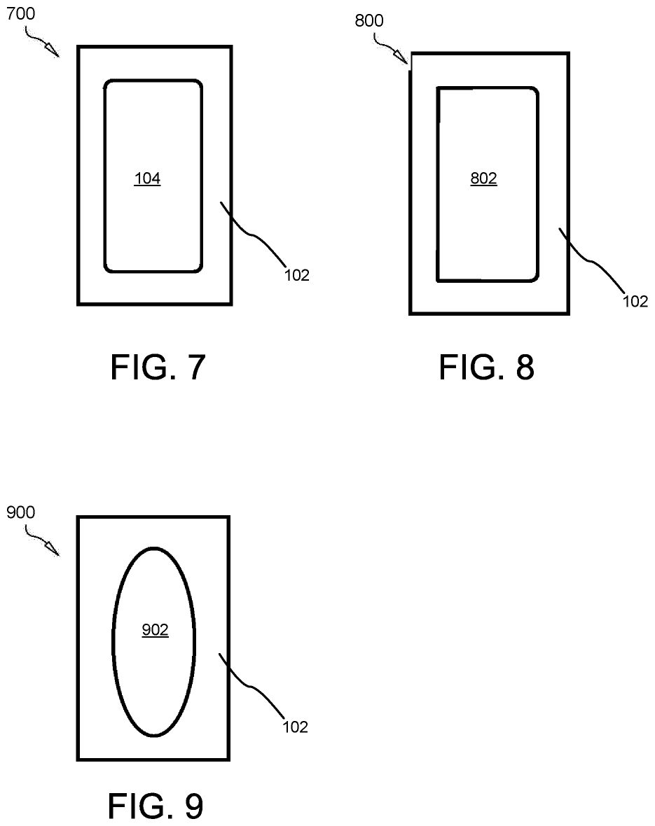

FIG. 7 is forward perspective view illustrating one embodiment of a handheld concrete tie disjunction implement in accordance with the present invention.

The channel 104 in the shown embodiment is rectangular with chamfered or rounded corners.

FIG. 8 is forward perspective view illustrating one embodiment of a handheld concrete tie disjunction implement in accordance with the present invention.

The channel 802 in the shown embodiment is rectangular with chamfered or rounded corners on only one side of the channel 802. The channel 802 may be rectangular.

FIG. 9 is forward perspective view illustrating one embodiment of a handheld concrete tie disjunction implement in accordance with the present invention.

The channel 902 in the shown embodiment is ovoid.

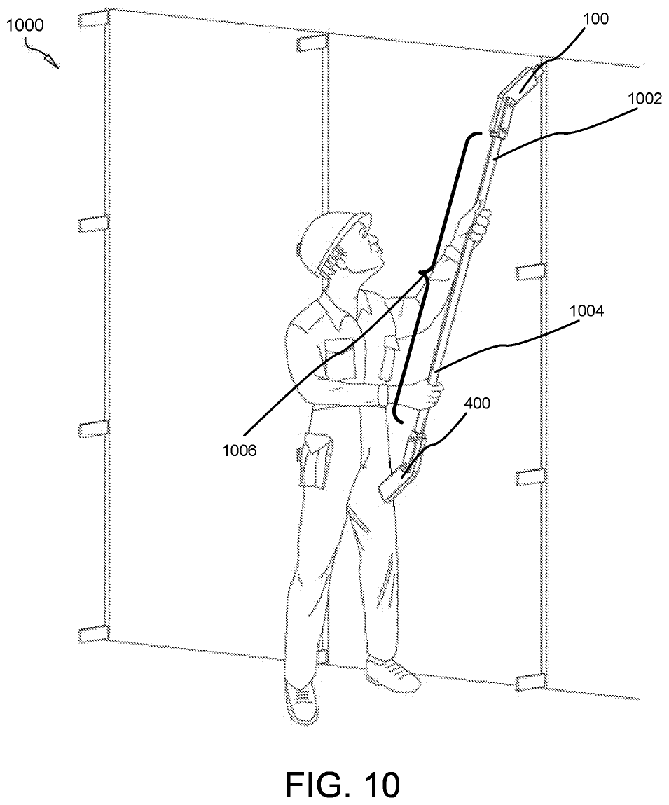

FIG. 10 is forward perspective view illustrating one embodiment of a handheld concrete tie disjunction implement 1000 in accordance with the present invention.

In some embodiments, the handle 1006 comprises a proximal end 1002 and a distal end 1004. The proximal end 1002 may be affixed to a head 100 while the distal end 1004 may be affixed to another head adapted to sheer a concrete tie of a different size than head 100, such as head 400.

In various embodiments, either or both of the heads 100, 400 affixed to the handle 1006 are interchangeable or permanently affixed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A handheld concrete tie disjunction implement comprising:
a chevron-shaped head defining a first hollow interior channel adapted to receive a concrete tie, the hollow interior channel traversing the head from an open front end to an open rearward end; and
a second hollow interior recess adapted to receive a handle.

2. The handheld concrete tie disjunction implement of claim 1, wherein the first hollow interior channel through a cross-section is one of ovoid and rectangular.

3. The handheld concrete tie disjunction implement of claim 1, wherein the handle is adapted to be moved to-and-fro to shear a concrete tie from a cement wall.

4. The handheld concrete tie disjunction implement of claim 1, further comprising a plurality of bores for receiving bolts affixing the head to a handle.

5. The handheld concrete tie disjunction implement of claim 1, further comprising a second chevron head defining a second hollow interior channel adapted to receive a concrete tie, the second hollow interior channel traversing the head from an open front end to an open rearward end.

6. A handheld concrete tie disjunction implement comprising:
a first L-shaped head defining a first hollow interior channel adapted to receive a concrete tie, the hollow interior channel traversing the head from an open front end to an open rearward end, the first L-shaped head defining a second hollow interior recess adapted to receive a handle;
a second L-shaped head defining a first hollow interior channel adapted to receive a concrete tie, the hollow interior channel traversing the head from an open front end to an open rearward end, the second L-shaped head defining a second hollow interior recess adapted to receive the handle;
the handle inserted into the first L-shaped head at a proximal end of the handle and the handle inserted into the second L-shaped head at a distal end of the handle.

7. The handheld concrete tie disjunction implement of claim 6, further comprising an elongate handle more than two feet in length.

8. The handheld concrete tie disjunction implement of claim 6, wherein the handle comprises two prongs adapted to straddle and affix to the head.

9. A handheld rebar disjunction implement comprising:
a first head defining a first hollow interior channel adapted to receive a concrete tie, the hollow interior channel traversing the head from an open front end to an open rearward end;
a second hollow interior recess adapted to receive a handle; and
an elongate handle more than two feet in length detachably affixable to the head.

10. The handheld concrete tie disjunction implement of claim 9, further comprising a second head defining a second hollow interior channel adapted to receive a concrete tie, the second hollow interior channel traversing the head from an open front end to an open rearward end.
